(19) United States
(12) Patent Application Publication
(10) Pub. No.: US 2006/0266301 A1
(43) Pub. Date: Nov. 30, 2006

(54) Adjustable length leash with an integrated waist belt

(76) Inventor: Jerzy Perkitny, Lakewood, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/441,435

(22) Filed: May 25, 2006

Related U.S. Application Data
(60) Provisional application No. 60/684,419, filed on May 25, 2005.

(51) Int. Cl. A01K 27/00; A62B 35/00

(52) U.S. Cl. 119/770

(57) ABSTRACT

The present invention relates to an adjustable length leash for selectively tethering an animal to a user's hand or waist. The adjustable length leash includes a belt, a hook attached to a first end of the belt, a fixed connector attached to the second end of the belt, and a movable connector slideably attached between the first and second ends of the belt. The movable connector is slideably engageable with the fixed connector. The adjustable length leash invention may also include a first belt loop adapted to fit about the user's wrist or hand. In addition, the fixed connector and the movable connector may engage to form a second belt loop. The second belt loop may be adapted to fit around the user's waist and the first belt loop may provide an attachment point for a secondary leash.

The present application claims domestic priority to provisional Application Ser. No. 60/684,419 filed on May 25, 2005.

### BACKGROUND

The present invention relates to the art of animal or pet restraint devices (commonly known as leashes). In particular, the present invention involves restraint devices that allow a user to restrain an animal in a hands-free manner.

Although hands-free animal restraint devices are known in the art, they possess a number of deficiencies. In most cases the devices are too complex, too heavy or bulky, or require an excessive number of components to function. Furthermore, these devices do not provide a method of quickly releasing the leash from the user in an emergency situation. Finally, the prior art devices are typically limited to a fixed length, a particular method of use, or a special configuration (such as the hands-free configuration).

The present invention provides an improved design for an animal restraint device that utilizes multiple configurations and a safer hands-free configuration.

### SUMMARY OF THE INVENTION

According to one aspect of the invention, an adjustable length leash is provided for selectively tethering a pet to a person's hand or waist. The adjustable length leash includes a belt, including a first end and a second end, a hook attached to the first end of the belt, a fixed connector attached to the second end of the belt, and a movable connector slideably attached to the belt, wherein the movable connector is selectively engageable with the fixed connector.

According to another aspect of the invention, a hands-free safety release leash is provided for selectively tethering an associated conventional leash to a person's waist. The hands-free safety release leash includes a belt, including a first end and a second end, a first connector attached to a first end of the belt, and a second connector secured to the belt in a manner spaced from the first connector. The first connector is selectively engageable to the second connector and a waist belt loop is defined when the first connector is engaged to the second connector. The waist belt loop is adapted to be secured about the person's waist. The hands-free safety release leash further includes a safety release device disposed at the second end of the belt. The safety release device includes a latched position and a release position and secures the belt to the associated conventional leash when in the latched position and releases the associated conventional leash from the belt when in the release position.

According to yet another aspect of the invention, an adjustable length hands-free leash is provided for selectively tethering a pet to a person's waist. The adjustable length hands-free leash includes a belt, a hook attached to the belt for securing the belt to an associated pet collar, a waist loop defined by a first end of the belt. The waist loop is adapted to be secured about the user's waist. The waist loop includes a first waist connector and a second waist connector selectively engageable with the first waist connector. The adjustable length hands-free leash further includes a leash portion defined by a central portion of the belt. The leash portion includes a first central connector and a second central connector selectively engageable with the first central connector.

### BRIEF DESCRIPTION OF THE DRAWINGS

The invention may take form in certain structures and components, several embodiments of which will be described in detail in this specification and illustrated in the accompanying drawings. In the drawings:

FIG. 1 is a perspective view of a first embodiment of an adjustable length leash according to the present invention.

FIG. 2 is a perspective view of the adjustable length leash of FIG. 1 illustrating the engagement of the fixed and movable quick connectors in order to shorten the leash and provide a greater restraint for the animal.

FIG. 3 is a perspective view of a second embodiment of an adjustable length leash illustrating the engagement of the fixed and movable connectors to form a waist belt loop that is worn by the user to provide a hands-free configuration.

FIG. 4 is a perspective view of a conventional retractable leash housing shown in FIG. 3 further illustrating an attachment point on the conventional retractable leash to which the adjustable length leash according to the present invention is attached.

FIG. 5 is a perspective view of the second embodiment of the adjustable length leash illustrating the use of the adjustable length leash in hands free operation where the conventional leash is secured to the user's waist by the waist belt loop.

FIG. 6 is a perspective view of the second embodiment of the adjustable length leash illustrating the location, orientation, and attachment of a safety release device.

FIG. 7 is a perspective view of the second embodiment of the adjustable length leash as shown in FIG. 5 illustrating the user's hand gripping the conventional retractable leash and the safety release cord about the user's wrist.

FIG. 8 is a perspective view of the second embodiment of the adjustable length leash as shown in FIG. 7 illustrating a triggered safety release device and subsequent detachment of the conventional leash from the adjustable length leash.

FIG. 9 is a perspective view of the first embodiment of the adjustable length leash as shown in FIG. 2 illustrating the use of the adjustable length leash as a short leash.

### DETAILED DESCRIPTION

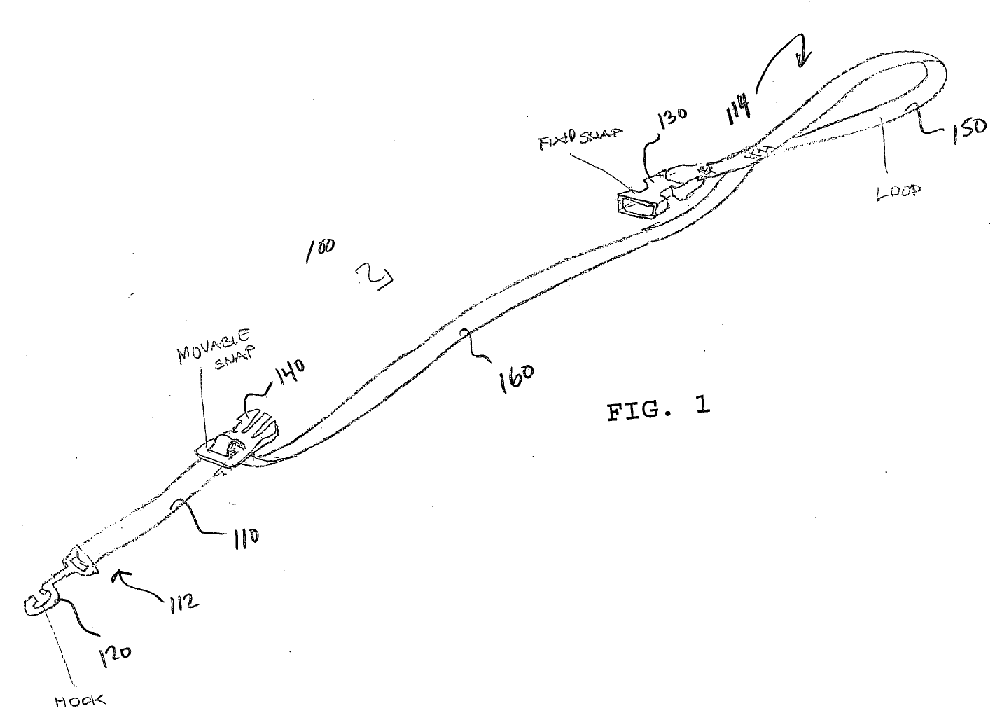

With reference to FIG. 1, a first embodiment of an adjustable length leash 100 is shown in a first use condition or configuration. The adjustable length leash 100 generally comprises a belt 110, a snap hook 120, a fixed connector 130 and a movable connector 140. The belt 110 includes a first end 112 and a second end 114. The belt 110 may be fabricated from nylon, rubber, leather, or any other material that is pliable and capable of withstanding significant tensile stress. Initially, the adjustable length leash 100 is constructed by passing the belt 110 through the movable connector 140. The movable connector 140, as shown in FIG. 1, includes two rectangular apertures. The first end 112 of the belt 110 is passed through one of the two apertures and out through the other. At this point, the snap hook 120 may be attached to the first end 112 of the belt 110. Typically, the belt material is attached to the snap hook 120 by passing an end portion of the belt material through an attachment loop of the snap hook 120 and then stitching the end portion back onto the belt material 110 itself. At the second end 114 of the belt 110, a fixed connector 130 is attached. Similar to the attachment method described with respect to the snap hook 120, the fixed connector 130 is attached to the second end 114 of the belt material 110. With respect to the first embodiment, it should be noted that the first end 112 includes the general structures associated with the end of the belt 110 proximal to the pet (i.e. a snap hook). Likewise, the second end 114 includes the general structures associated with the end of the belt 110 closest to the user or person (i.e. handle, hand loop, or fixed connector).

The fixed and movable connectors 130,140 may be of conventional plastic or metallic construction and are designed such that they are snappingly engageable with the other. By way of example, the movable connector 140 may be a male type connector and the fixed connector 130 may be a female type. Typically, depressible elastic prongs in the male connector are designed to intercept a set of corresponding prong apertures in the female connector. Sliding the male connector entirely into the female connector will result in the prongs engaging the apertures in the female connector to form a resilient coupling therebetween. To release the coupling, the user depresses the prongs inwardly while pulling the connectors apart.

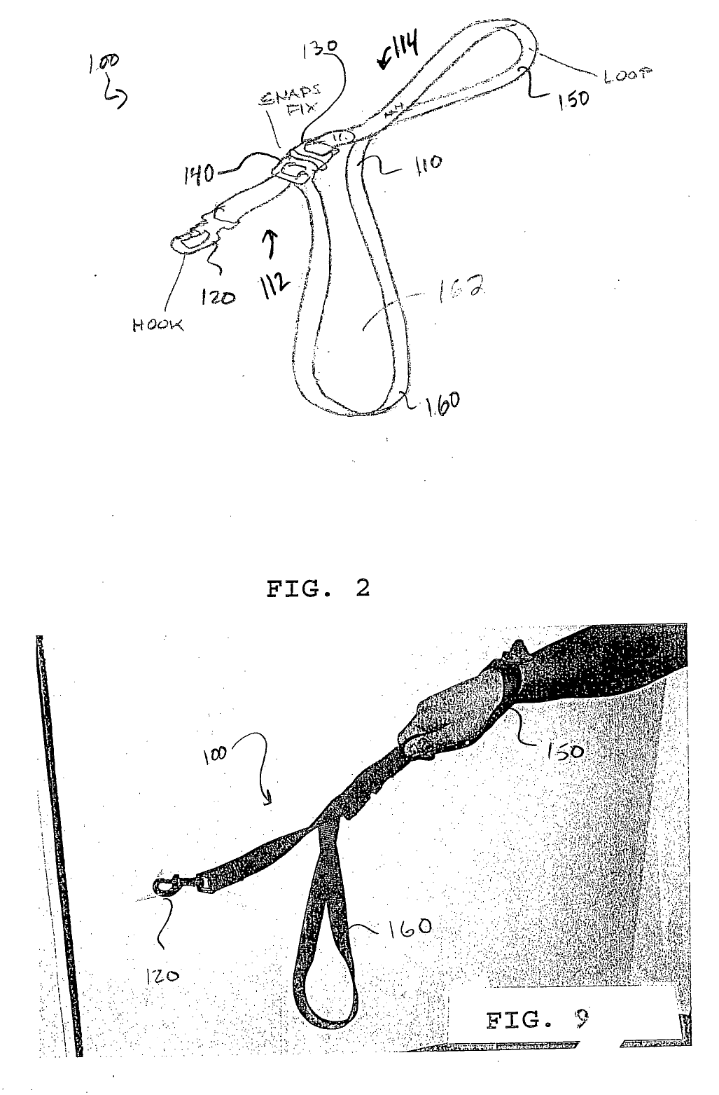

In addition, a hand loop 150 may be formed at the second end 114 out of the belt material by folding a portion of the second end 114 of the belt 110 back over onto the belt 110. The hand loop 150 is sized appropriately to provide a large enough loop to slide over the user's hand. The hand loop 150 is closed and secured by stitching together the two portions of the belt material that are touching. A central portion 160 of the adjustable length leash 100 may be made in varying lengths to accommodate any number of user preferences. In this embodiment, the user connects the snap hook 120 to an animal collar and grips the hand loop portion 150, thereby restraining the animal or pet as necessary. By comparison to FIG. 2, the leash in the first use condition of FIG. 1 provides the maximum operating length of the adjustable length leash and the greatest amount of freedom for the restrained animal.

Now with reference to FIG. 2, a second use condition of the adjustable length leash 100 is shown. In this condition, the fixed connector 130 and the moveable connector 140 are engaged, effectively shortening the overall operating length of the adjustable length leash 100. The effective leash length can be generally defined as the distance between where the person grips or is secured to the leash and where the pet is secured to the leash. As such, the first end 112 and the second end 114 are closer together causing the central portion 160 to form a slack loop 162. Naturally, the movable connector 140 may be slid as desired along the length of the belt material 110 to increase or decrease the operating length of the adjustable length leash 100. Applications where a shorter leash may be desired include when walking the animal in highly congested areas, or when the animal has an aggressive tendency towards other animals or humans.

With reference to FIG. 9, the first embodiment of the adjustable length leash 100 is shown in the second use position. As shown in FIG. 9, the user has placed the hand loop 150 about his wrist. In addition, the slack loop portion 162 is shown hanging or dangling while the snap hook 120 is attached to the animal's collar.

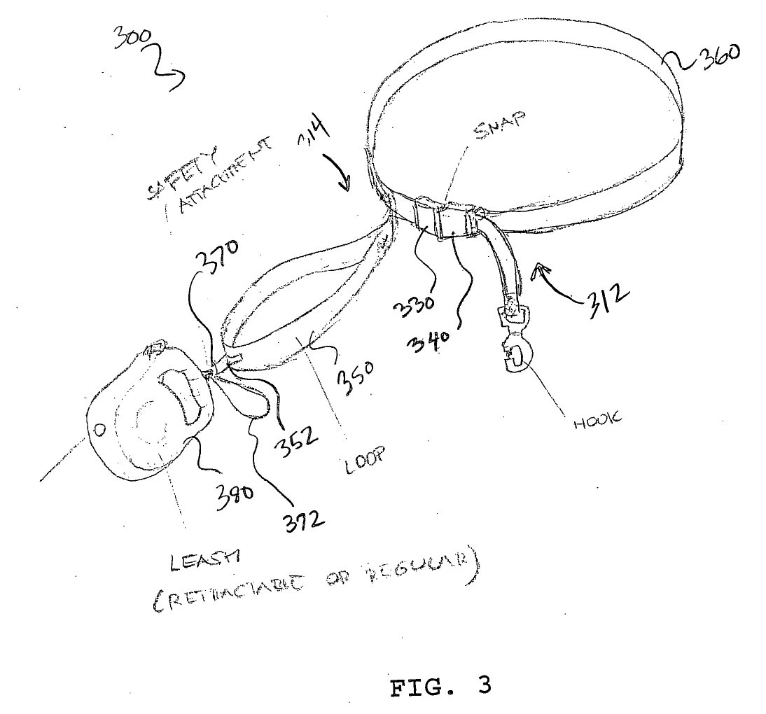

Now with reference to FIG. 3, a second embodiment of an adjustable length leash 300 is shown. As before, the second embodiment of an adjustable length leash 300 includes similar components and structure as with the first embodiment. However, the configuration of the second embodiment is substantially different. In fact, the adjustable length leash 300 is now shown in a use condition that is oriented essentially 180 degrees from the orientation shown with respect to the first embodiment. In particular, a first end 312 of the belt is now proximal to the user and a second end 314 of the belt is proximal to the pet to be tethered. In addition, the slack loop 162 (FIG. 2) is now employed as a waist belt loop 360 intended to fit around the waist of the user of the adjustable length leash 300. In a manner similar to adjusting the operating length of the adjustable length leash shown in FIG. 2, the waist belt loop 360 may be adjusted by sliding a moveable connector 340 and engaging a fixed connector 330 so that the waist belt loop 360 fits snuggly about the user's waist. Also, the former hand loop 150 of the first embodiment which was used to grip the adjustable length leash 100 is now employed as an intermediate loop 350 intended to attach the waist belt loop 360 to a conventional leash 380. To facilitate the attachment of the intermediate loop 350 to the conventional leash 380, an intermediate belt loop attachment point 352 is stitched to the midpoint of the intermediate belt loop 350. It should be noted that the conventional leash 380 may be of the retractable type (as shown in FIGS. 3 through 8), a fixed type, or any other hand-held leash device for restraining a pet.

In addition, the second embodiment of the adjustable length leash 300 includes a safety release device 370, which is shown in FIG. 3 between the intermediate loop 350 and the conventional leash 380. Under certain circumstances, it may be desirable to release the conventional leash 380 from the adjustable length leash 300. Such circumstances would exist, for example, when the user is attempting to restrain the animal or pet and subsequently loses their footing. Now, the user is in a more precarious situation and may be put at further risk if the animal is powerful or of large stature. At this point, the user may prefer to release the animal so as to avoid injury or further injury to himself. The user may release the conventional leash 380 from the adjustable length leash 300 by triggering the safety release device 370.

Triggering of the safety release device 370 is accomplished when a slight upward pressure is applied to a safety release cord 372. When the user pulls on the safety release cord 372, which may be conveniently worn about the user's wrist, a release pin is displaced permitting a clasp portion of the safety release device to open. When the clasp portion is opened the conventional leash 380 will disengage from the safety release device 370. This type of safety release mechanism is known in other environments, such as sailing.

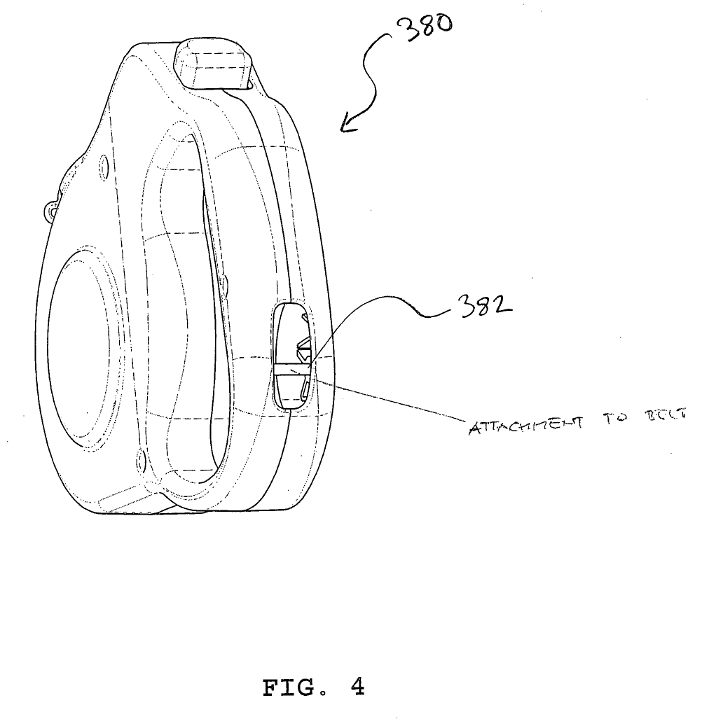

Now with reference to FIG. 4, a perspective view of the conventional retractable leash 380 is shown. Along a rear portion of the conventional leash 380, an attachment point 382 is provided. The convention leash attachment point 382 is utilized by the safety release device 370 in order to attach the leash 380 to the intermediate loop 350 of the second embodiment of the adjustable length leash 300 via the intermediate belt loop attachment point 352.

Now with reference to FIG. 5, the adjustable length leash 300 is shown as attached to the user. As shown in FIG. 5, the waist belt loop 360 is snuggly fitted about the user's waist and the leash 380 is attached via the safety release device 370 to the intermediate loop 350. In this hands-free configuration, the user may walk their animal or pet without having to hold onto the conventional leash 380 or the adjustable length leash 300. This embodiment can be useful if the operator wishes to use his hands for other purposes while walking the pet. If necessary, the user or operator may still be able to reach down and grasp the safety release cord 372 in order to release the conventional leash 380 from the intermediate loop 350.

Now with reference to FIG. 6, a close-up view of the triggered safety release device 370 is shown. FIG. 6 also illustrates the coupling between the intermediate loop 350 and the conventional leash 380. One end of the safety release device is attached to the intermediate loop attachment point 352. The other end of the safety release device 370 accepts the attachment point 382 of the conventional leash 380. As shown in FIG. 6, the typical operation of the safety release device 370 is via the safety release cord 372 which is attached to a pin. When the pin is pulled in an upward direction, it allows the hinged clasp portion to swing open thereby releasing the conventional leash 380.

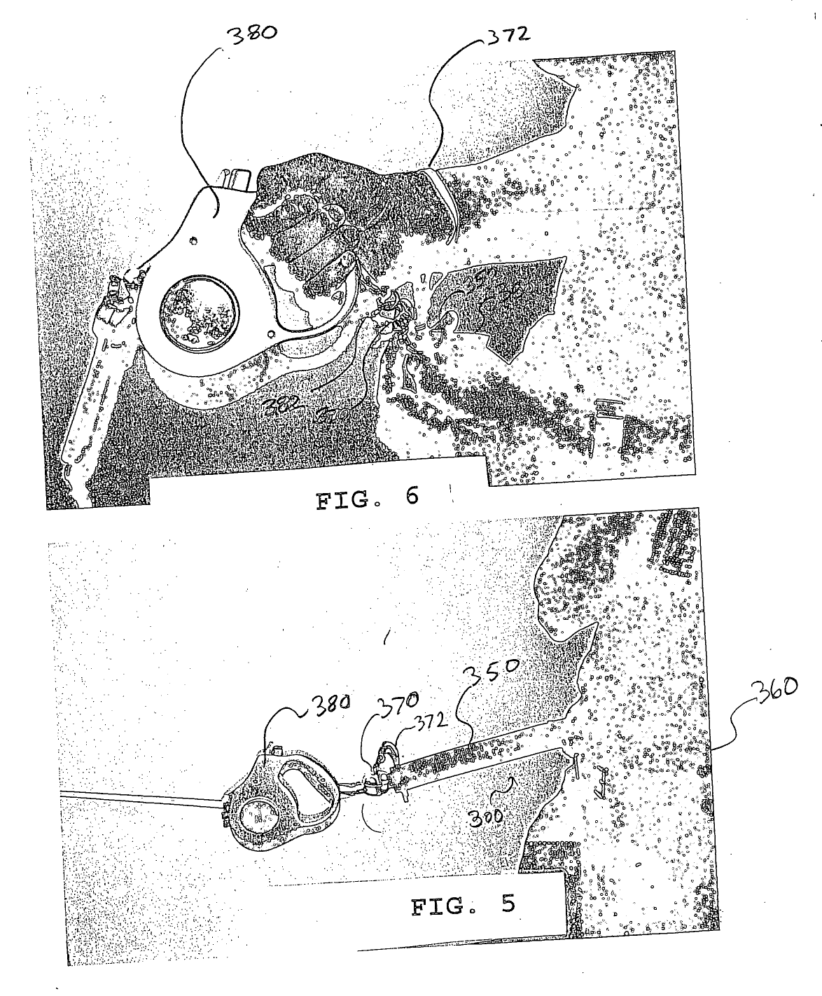

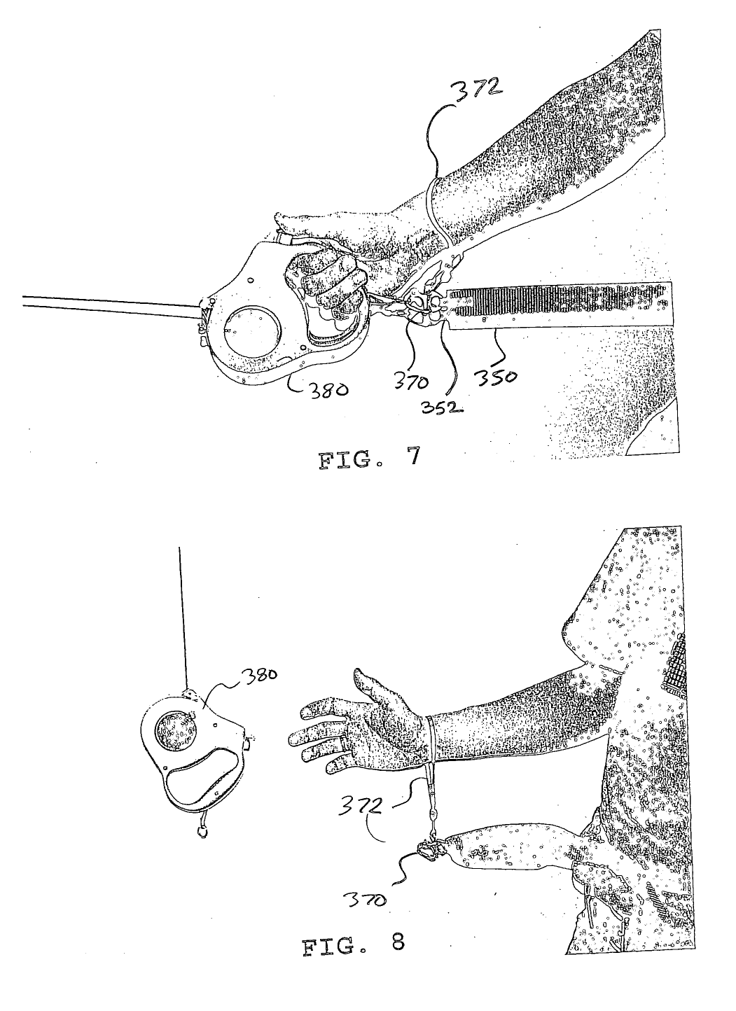

With reference to FIG. 7, the user is shown as gripping the conventional (retractable type) leash 380, with the safety release cord 372 being fitted about the user's wrist. The intermediate loop attachment point 352, to which the safety release device 370 is attached, is clearly visible. FIG. 7 also illustrates the scenario discussed previously, where the animal or pet is generating a large amount of tension on the conventional leash 380 and the user desires to release himself or herself from the conventional leash 380. In order to do so, the user must first release the conventional leash 380. As shown in FIG. 8, after the user releases the conventional leash 380, the conventional leash 380 will lurch forward causing tension in the safety release cord 372. Tension in the safety release cord 372 will displace the pin in the safety release device 370 and thereby activate the safety release device 370.

Furthermore, a third embodiment of an adjustable length leash may include an orientation and structure similar to that of the second embodiment, differing primarily in that an additional set of engageable connectors are provided for along a central portion of the belt. Specifically, a first end of the belt includes a waist loop portion having a first set of engageable connectors (one of which may be moveable) for adjusting the length of the waist portion. A second end of the belt includes a snap hook for attaching the third embodiment of the adjustable length leash to a pet's collar or to a conventional leash (as described with reference to the first and second embodiments). The central portion of the third embodiment of the adjustable length leash includes the additional or second set of engageable connectors. Similar to the connectors of the first embodiment, the second set of engageable connectors act to lengthen or shorten the overall effective length of the leash. In this regard, an adjustable length leash is provided having not only an adjustable waist loop portion but also an adjustable central portion.

Disclosed herein has been an adjustable length leash which offers a variety of configurations, including a mechanism for safely and quickly releasing the leash when in the hands-free configuration.

In a first embodiment, the adjustable length leash includes a belt, a hook attached to a first end of the belt, a fixed connector attached to the second end of the belt, and a movable connector slideably attached to a central portion of the belt. Adjustment of the leash length provides a greater or lesser degree of freedom for the animal being restrained. When the two connectors are disengaged, the leash is at its maximum length. In addition, the second end of the belt is folded back and is attached to the belt to form a hand loop. Here, the hand loop is adapted to slide over the user's hand.

When the movable connector is coupled with the fixed connector, the user can shorten the operating length of the adjustable length leash. The operating length of the adjustable length leash will decrease as the moveable connector is slid toward the first end of the belt. This construction allows the user to restrain the animal to a greater extent.

In a second embodiment, the movable connector is adjusted appropriately such that the central portion of the belt will fit snuggly about the user's waist. In this embodiment the hand loop can be used as an intermediate loop to attach the adjustable length leash to a conventional leash. This embodiment provides for a hands-free technique of restraining an animal to the user's body. To provide a greater degree of safety, a safety release device may be inserted between the intermediate loop and the conventional leash to allow the user to quickly disconnect the conventional leash under exigent circumstances.

In a third embodiment, an additional or second set of engageable connectors are provided allowing for an adjustable waist portion as well as an adjustable central portion. By adjusting the central portion of the third embodiment the overall effective length of the leash can be changed in a manner similar to that of the first embodiment.

Several exemplary embodiments have thus been described. Modifications and alterations may occur to others upon reading and understanding the preceding detailed description. It is intended that the exemplary embodiments be construed as including all such modifications and alterations insofar as they come within the scope of the appended claims or the equivalents thereof.

Having thus described the preceding embodiments in detail, the invention is now claimed to be:

1. An adjustable length leash for selectively tethering a pet to a person's hand or waist, the adjustable length leash comprising:
a belt, including a first end and a second end;
a hook attached to the first end of the belt;
a fixed connector attached to the second end of the belt; and
a movable connector slideably attached to the belt, wherein the movable connector is selectively engageable with the fixed connector.

2. The adjustable length leash of claim 1, further comprising a first belt loop defined on the belt.

3. The adjustable length leash of claim 2, wherein the first belt loop is adapted to slide over the person's hand.

4. The adjustable length leash of claim 2, wherein the fixed connector and the movable connector engage to form a second belt loop.

5. The adjustable length leash of claim 4, wherein the second belt loop reduces an effective length of the belt by a distance equivalent to a length of the second belt loop.

6. The adjustable length leash of claim 4, wherein the second belt loop is adapted to fit around the operator's waist.

7. The adjustable length leash of claim 6, wherein the first belt loop includes an attachment point for an associated conventional leash.

8. The adjustable length leash of claim 7, wherein a safety release device is disposed between the attachment point and the associated conventional leash.

9. A hands-free safety release leash for selectively tethering an associated conventional leash to a person's waist, the hands-free safety release leash comprising:
a belt, including a first end and a second end;
a first connector attached to a first end of the belt;
a second connector secured to the belt in a manner spaced from the first connector, the first connector being selectively engageable to the second connector, a waist belt loop being defined when the first connector is engaged to the second connector, the waist belt loop adapted to be secured about the person's waist; and
a safety release device disposed at the second end of the belt, the safety release device including a latched position and a release position, the safety release device securing the belt to the associated conventional leash when in the latched position and releasing the associated conventional leash from the belt when in the release position.

10. The hands-free safety release leash of claim 9, wherein the second connector is slideably attached along the belt for adjusting a length of the first belt loop.

11. The hands-free safety release leash of claim 9, wherein the safety release device includes a safety release cord adapted to be held by a person's hand for triggering the safety release device from the latched position to the release position.

12. The hands-free safety release leash of claim 9, wherein the safety release device includes a safety release cord loop adapted to slide over a person's hand for triggering the safety release device from the latched position to the release position.

13. The hands-free safety release leash of claim 9, further including a hook attached to the first end of the belt.

14. The hands-free safety release leash of claim 9, further including an attachment point for the safety release device on the second end of the belt.

15. An adjustable length hands-free leash for selectively tethering a pet to a person's waist, the adjustable length hands-free leash comprising:
a belt;
a hook attached to the belt for securing the belt to an associated pet collar;
a waist loop defined by a first end of the belt, the waist loop adapted to be secured about the user's waist, the waist loop including a first waist connector and a second waist connector selectively engageable with the first waist connector; and
a leash portion defined by a central portion of the belt, the leash portion including a first central connector and a second central connector selectively engageable with the first central connector.

16. The adjustable length hands-free leash of claim 15, wherein an effective leash length is defined between the waist loop and the hook.

17. The adjustable length hands-free leash of claim 16, wherein the first central connector and the second central connector define a first effective leash length when engaged and a second effective leash length when disengaged, the first effective leash length being shorter than the second effective leash length.

18. The adjustable length hands-free leash of claim 15, wherein at least one of the first waist connector or the second waist connector is slideably attached to the belt.

19. The adjustable length hands-free leash of claim 15, wherein at least one of the first waist connector or the second waist connector is slideably attached to the belt.

20. The adjustable length hands-free leash of claim 15, further including a safety release device attached to the belt, the safety release device including a latched position and a release position, the safety release device securing the belt to the associated pet collar when in the latched position and releasing the associated pet collar from the belt when in the release position.
